(19) United States
(12) Patent Application Publication
(10) Pub. No.: US 2013/0186853 A1
(43) Pub. Date: Jul. 25, 2013

(54) METHOD OF MANUFACTURING AT LEAST ONE LIQUID CRYSTAL DISPLAY ELEMENT

(71) Applicant: Panasonic Liquid Crystal Display Co., Ltd., Himeji-shi (JP)

(72) Inventors: Katsuto SUGIMOTO, Hyogo (JP); Takao TANAKA, Hyogo (JP); Kazuya NAKAMURA, Hyogo (JP)

(73) Assignee: PANASONIC LIQUID CRYSTAL DISPLAY CO., LTD., Himeji-shi (JP)

(21) Appl. No.: 13/748,190

(22) Filed: Jan. 23, 2013

(30) Foreign Application Priority Data
Jan. 24, 2012 (JP) 2012-012484

(51) Int. Cl. G02F 1/1333

(52) U.S. Cl. CPC G02F 1/133351
USPC 216/23

(57) ABSTRACT

Provided is a method of manufacturing at least one liquid crystal display element, including: a first step of grinding an end surface of a glass substrate pair including two glass substrates overlapping with each other; and a second step of subjecting a surface of the glass substrate pair to chemical polishing.

### CROSS-REFERENCE TO RELATED APPLICATION

The present application claims priority from Japanese application JP 2012-012484 filed on Jan. 24, 2012, the content of which is hereby incorporated by reference into this application.

### BACKGROUND OF THE INVENTION

1. Field of the Invention

The present invention relates to a method of manufacturing at least one liquid crystal display element.

2. Description of the Related Art

As a method of manufacturing a liquid crystal display element, there is known a method of cutting a large-size glass substrate called a mother glass substrate to cut out each individual liquid crystal display element. FIG. 14 is a flow chart illustrating a conventional process of manufacturing a liquid crystal display element.

FIG. 15 is a plan view of glass substrates 101a and 101b, and FIG. 16 is a sectional view of the glass substrates 101a and 101b, taken along the line XVI-XVI of FIG. 15. In the conventional manufacturing steps, first, as illustrated in FIGS. 15 and 16, a seal member 103 is arranged between the two glass substrates 101a and 101b. For example, the seal member 103 is arranged so as to be located in the vicinity of an end surface 102 in two lines. As such glass substrates 101a and 101b in a pair, for example, a color filter substrate and a thin film transistor (TFT) substrate are used. Such glass substrates 101a and 101b generally have surfaces opposed to each other, which are each covered with a resin-based film 104.

Subsequently, the glass substrates 101a and 101b are aligned with respect to each other based on an alignment mark 105. Then, the glass substrates 101a and 101b are bonded to each other so that the glass substrates 101a and 101b overlap with each other through intermediation of the seal member 103. After that, the seal member 103 is cured. In this manner, a glass substrate pair 101 including the two glass substrates 101a and 101b is formed. Subsequently, peripheral edge portions of the glass substrate pair 101 are cut. When the peripheral edge portions are cut, there are cases where a broken glass edge 102a protruding on the outer peripheral side of the glass substrate pair 101 is generated at the end surface 102. Subsequently, the end surface 102 of the glass substrate pair 101 is chamfered. After that, the glass substrate pair 101 is cleaned to remove glass powder and the like. Subsequently, the glass substrate pair 101 is immersed in polishing liquid to subject surfaces 101a₁ and 101b₁ to chemical polishing. After the chemical polishing, the end surface 102 is polished. After that, the glass substrate pair 101 is conveyed to a position of a cutting apparatus to perform cutting for each liquid crystal display element section 106. The glass substrate pair 101 is cut as described above, and thus individual liquid crystal display elements are cut out.

### SUMMARY OF THE INVENTION

FIG. 17 is a sectional view illustrating a shape of the end surface 102 of the glass substrate pair 101 after the chemical polishing in the conventional process. The resin-based film 104 has a rate of solution during chemical polishing lower than that of each glass substrate 101a or 101b. Therefore, through chemical polishing, the glass substrates 101a and 101b around the resin-based film 104 remain undissolved as illustrated in FIG. 17, and the end surface 102 is liable to have a sharp-edged shape. A sharp-edged part 102b of the end surface 102 has a plate thickness smaller than that of each glass substrate 101a or 101b. Therefore, when the glass substrate pair 101 is conveyed or cut, cracks and chips maybe easily generated at the sharp-edged part 102b.

FIG. 18 is a sectional view illustrating a state in which an outer periphery sealing agent 107 is applied to the end surface 102 of the glass substrate pair 101 in the conventional process. In order to prevent generation of the sharp-edged part 102b, as illustrated in FIG. 18, there is disclosed a method of performing chemical polishing under a state in which the end surface 102 and the broken glass edge 102a are covered with the outer periphery sealing agent 107. However, if the broken glass edge 102a is generated at the end surface 102 when the glass substrate pair 101 is cut and chamfered, the outer periphery sealing agent 107 cannot cover a part of a gap 109 between the glass substrates 101a and 101b on the end surface 102 side (opening portion 109a) at a sufficient thickness. Therefore, a pressure for enabling the outer periphery sealing agent 107 to enter the opening portion 109a is not sufficiently applied to the opening portion 109a. As a result, the outer periphery sealing agent 107 does not sufficiently enter the gap 109, and thus there arises a problem that the outer periphery sealing agent 107 peels off from the end surface 102 during chemical polishing to adhere to the surfaces 101a₁ and 101b₁.

However, in the conventional method, it is difficult to prevent cracks and chips when the glass substrate pair 101 is cleaned after chemical polishing, or when the glass substrate pair 101 is conveyed before polishing of the end surface 102. Further, the end surface 102 is polished after the chemical polishing, and hence the problem of peeling off of the outer periphery sealing agent 107 cannot be solved.

The present invention has been made in view of the above-mentioned circumstances, and therefore has an object to provide a method of manufacturing at least one liquid crystal display element, which is capable of preventing generation of cracks and chips in the manufacturing steps.

In order to solve the above-mentioned problems, the present invention includes the following configurations. That is, according to a first exemplary embodiment of the present invention, there is provided a method of manufacturing at least one liquid crystal display element, including: a first step of grinding an end surface of a glass substrate pair including two glass substrates overlapping with each other; and a second step of subjecting a surface of the glass substrate pair to chemical polishing.

Further, according to a second exemplary embodiment of the present invention, it is preferred that the method of manufacturing at least one liquid crystal display element further include, prior to the first step, bonding the two glass substrates to each other by a seal member to form the glass substrate pair, and that the first step include grinding the end surface until the seal member is exposed.

Further, according to a third exemplary embodiment of the present invention, it is preferred that the method of manufacturing at least one liquid crystal display element further include, between the first step and the second step, sealing a region between respective end surfaces of the two glass substrates with an outer periphery sealing agent.

Further, according to a fourth exemplary embodiment of the present invention, it is preferred that the method of manufacturing at least one liquid crystal display element further include, after the second step: cutting the glass substrate pair to cut out each individual liquid crystal display element; and grinding an end surface of the each individual liquid crystal display element.

### BRIEF DESCRIPTION OF THE DRAWINGS

In the accompanying drawings:

FIG. 1 is a flow chart of a method of manufacturing at least one liquid crystal display element according to the present invention;

FIG. 2A is a plan view of a glass substrate pair;

FIG. 2B is a sectional view taken along the line IIB-IIB of FIG. 2A;

FIG. 3 is a sectional view of the glass substrate pair, taken along the line IIB-IIB of FIG. 2A;

FIG. 4 is a schematic view illustrating a step of grinding an end surface of the glass substrate pair;

FIG. 5A is a photograph showing the end surface of the glass substrate pair before grinding;

FIG. 5B is a photograph showing the end surface of the glass substrate pair after grinding;

FIG. 6 is a sectional view of the glass substrate pair after grinding the end surface thereof, taken along the line IIB-IIB of FIG. 2A;

FIG. 7 is a sectional view illustrating a shape of the end surface of the glass substrate pair in FIG. 6 after chemical polishing;

FIG. 8 is a plan view illustrating a state in which the end surface of the glass substrate pair is ground;

FIG. 9 is a sectional view taken along the line IX-IX of FIG. 8;

FIG. 10 is a sectional view illustrating the glass substrate pair in FIG. 9 after chemical polishing;

FIG. 11A is a sectional view illustrating a state in which an outer periphery sealing agent is applied to the end surface of the glass substrate pair;

FIG. 11B is a sectional view illustrating the glass substrate pair after chemical polishing;

FIG. 12A is a plan view illustrating an individual piece of a liquid crystal display element;

FIG. 12B is a sectional view illustrating the liquid crystal display element, taken along the line XIIB-XIIB of FIG. 12A;

FIG. 12C is a partial enlarged view of a region XIIC of FIG. 12A;

FIG. 13A is a plan view illustrating a shape of the individual piece of FIG. 12A after the end surface thereof is ground;

FIG. 13B is a sectional view of the liquid crystal display element, taken along the line XIIIB-XIIIB of FIG. 13A;

FIG. 13C is a partial enlarged view of a region XIIIC of FIG. 13A;

FIG. 14 is a flow chart of a method of manufacturing a liquid crystal display element in a conventional process;

FIG. 15 is a plan view illustrating a state in which an end surface of a glass substrate pair is ground in the conventional process;

FIG. 16 is a sectional view of the glass substrate pair in the conventional process, taken along the line XVI-XVI of FIG. 15;

FIG. 17 is a sectional view illustrating a shape of the end surface of the glass substrate pair after chemical polishing in the conventional process; and

FIG. 18 is a sectional view illustrating a state in which an outer periphery sealing agent is applied to the end surface of the glass substrate pair in the conventional process.

### DETAILED DESCRIPTION OF THE INVENTION

In the following, a method of manufacturing at least one liquid crystal display element according to a first embodiment of the present invention is described with reference to the drawings. Note that, in some cases, the drawings referred to in the following description illustrate characteristic parts in an enlarged manner for the sake of easy understanding of the features, and the dimensional ratio and the like of each component need not be the same as those of the actual component. Further, the materials, dimensions, and the like exemplified in the following description are merely examples, and the present invention is not limited thereto. Modifications can be made as appropriate without departing from the gist of the present invention.

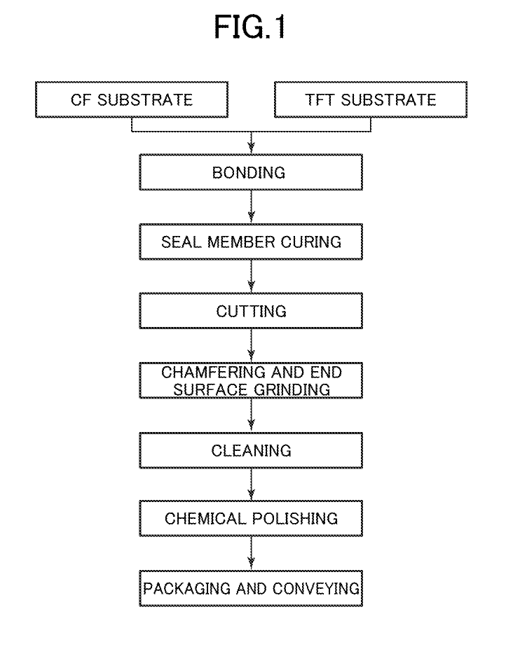

FIG. 1 is a flow chart of the method of manufacturing at least one liquid crystal display element according to the present invention. The method of manufacturing at least one liquid crystal display element of this embodiment includes a first step of grinding an end surface 2 of a glass substrate pair 1 including glass substrates 1a and 1b overlapping with each other, and a second step of subjecting surfaces 1a₁ and 1b₁ of the glass substrate pair 1 to chemical polishing. In the following, each step is described in detail.

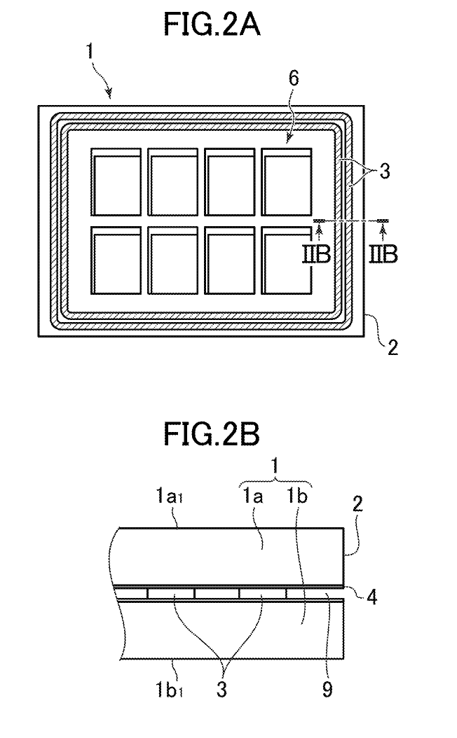

FIG. 2A is a plan view of the glass substrate pair 1, and FIG. 2B is a sectional view taken along the line IIB-IIB of FIG. 2A. First, as illustrated in FIGS. 2A and 2B, for example, a seal member 3 is arranged between the two glass substrates 1a and 1b. The seal member 3 is arranged so as to be located in the vicinity of the end surface 2 of each of the glass substrates 1a and 1b. A component to be arranged in the vicinity of the end surface 2 is not limited to the seal member 3, and an arbitrary sealing agent may be used. Note that, the end surface 2 in this embodiment refers to an outer peripheral side surface of each of the glass substrates 1a and 1b. Further, at least one liquid crystal display element section 6 is provided between the glass substrates 1a and 1b. As such glass substrates 1a and 1b in a pair, for example, a color filter substrate and a thin film transistor (TFT) substrate can be used. The glass substrates 1a and 1b each have one surface covered with a resin-based film 4.

Subsequently, the glass substrates 1a and 1b are overlapped with each other so that the surfaces covered with the resin-based film 4 are opposed to each other. Subsequently, the seal member 3 is cured. The seal member 3 is arranged between the glass substrates 1a and 1b, and hence the glass substrates 1a and 1b are bonded to each other under a state in which a gap 9 is maintained. With this, the glass substrate pair 1 including the two glass substrates 1a and 1b is formed.

Subsequently, the glass substrate pair 1 is cut so that an outer peripheral region of the glass substrate pair 1 on an outer peripheral side with respect to the seal member 3 is cut off. As a method of cutting the glass substrate pair 1, for example, there may be employed a method of forming scratches in the surface 1a₁ of the glass substrate 1a and the surface 1b₁ of the glass substrate 1b, the scratches being perpendicular to the surfaces 1a₁ and 1b₁, and then splitting the glass substrate pair 1 under pressure, or a method of cutting the glass substrate pair 1 with use of a dicing blade. The method of cutting the glass substrate pair 1 is not limited to the above-mentioned methods and may be arbitrarily selected.

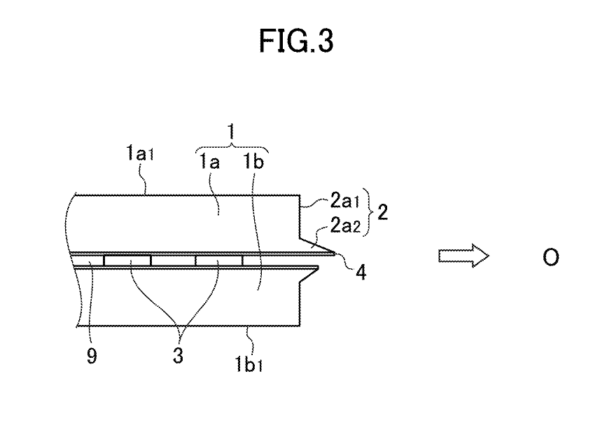

FIG. 3 is a sectional view of the glass substrate pair 1, taken along the line IIB-IIB of FIG. 2A. When the glass substrate pair 1 is cut, the glass substrates 1a and 1b are cut in a direction perpendicular to the surfaces 1a₁ and 1b₁. Thus, a cut surface (end surface 2) is formed. In this embodiment, in the end surface 2, a surface perpendicular to the surfaces 1a₁ and 1b₁ is referred to as a perpendicular cut surface 2a₁, and a part protruded toward the outer periphery (O direction in the figure) off from the perpendicular cut surface 2a₁ is referred to as a broken glass edge 2a₂. Generally, such a broken glass edge 2a₂ has a sharp-edged shape.

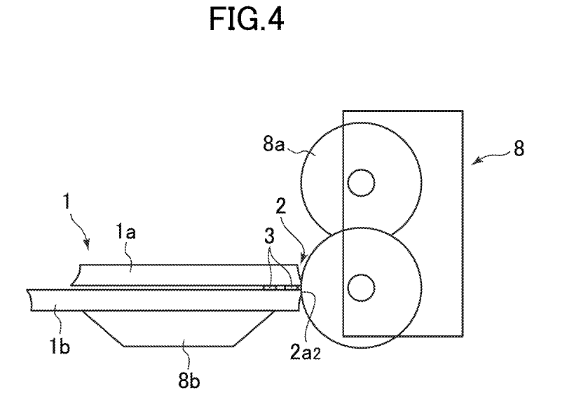

FIG. 4 is a schematic view illustrating a step of grinding the end surface 2 of the glass substrate pair 1. Subsequently, as illustrated in FIG. 4, for example, with use of a grinding machine 8 including a rotatable grinding wheel 8a such as a diamond wheel and a chamfering surface plate 8b, chamfering is performed as well as grinding of the broken glass edge 2a. Grinding in this embodiment refers to a method of rotating the grinding wheel 8a under a state in which the grinding wheel 8a and the end surface 2 are brought into contact to each other to grind the end surface 2.

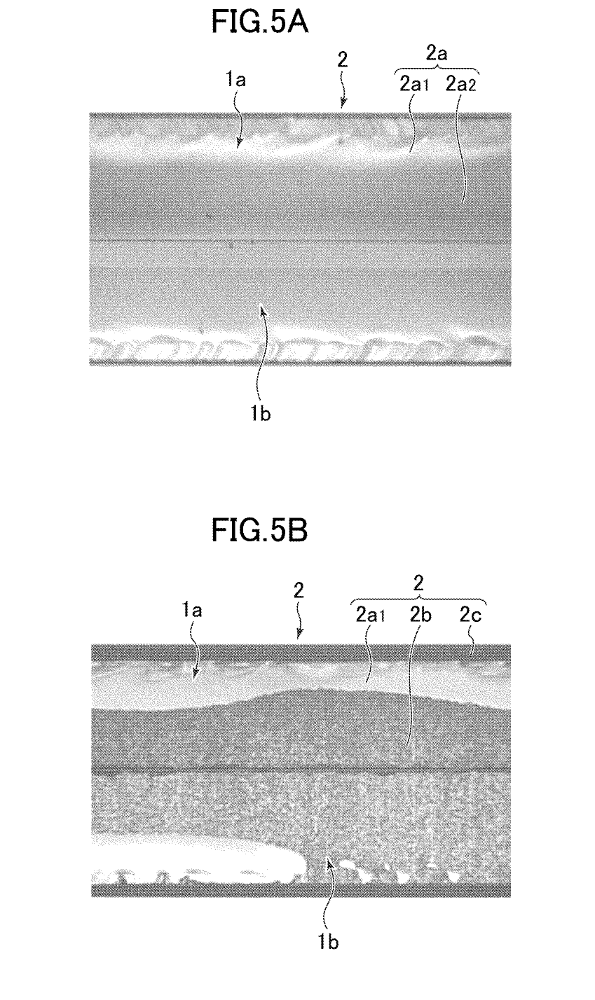

FIG. 5A is a photograph showing the end surface 2 of the glass substrate pair 1 before grinding, and FIG. 5B is a photograph showing the end surface 2 of the glass substrate pair 1 after grinding. Further, FIG. 5A is a photograph obtained by photographing the end surface 2 before grinding from the outer peripheral side (O direction in FIG. 3) of the glass substrate pair 1.

As illustrated in FIG. 5B, the broken glass edge 2a₂ is removed by the grinding. Then, in a region which used to be the broken glass edge 2a₂, an end surface ground portion 2b is formed, which is a surface perpendicular to the surfaces 1a₁ and 1b₁. With this, the perpendicular cut surface 2a₁ and the end surface ground portion 2b each become a substantially flat surface.

In the grinding of this embodiment, the grain size of the grinding wheel 8a, the grade of the grain, and the rotational speed of the grinding wheel 8a to be used in the grinding machine 8 are adjusted as appropriate so that the surface roughness of the end surface ground portion 2b is greater than that of the perpendicular cut surface 2a₁, and so that the end surface ground portion 2b has fine irregularities. The end surface ground portion 2b which is substantially flat but has fine irregularities as described above means that a surface is flat in a long period but locally has a high surface roughness. Further, at the time of the grinding, chamfering of the end surface 2 is simultaneously performed. With this, regions of the end surface 2 on the surface 1a₁ side and on the surface 1b₁ side are removed, and thus chamfered portions 2c are formed. After that, the glass substrate pair 1 is cleaned.

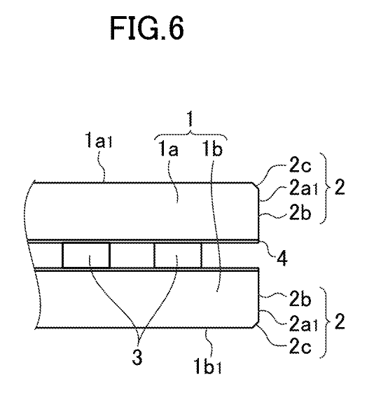

FIG. 6 is a sectional view of the glass substrate pair 1 after the end surface 2 thereof is ground. Subsequently, the glass substrate pair 1 is immersed in chemical polishing liquid. Then, the surfaces 1a₁ and 1b₁ are subjected to chemical polishing until the plate thickness of each of the glass substrates 1a and 1b is reduced to an arbitrary plate thickness. The chemical polishing liquid used at this time may have an arbitrary composition that is selected as appropriate in accordance with a desired rate. Note that, the opposing surfaces of the respective glass substrates 1a and 1b are each covered with the resin-based film 4, and hence only the outer surfaces 1a₁ and 1b₁ of the glass substrate pair 1 are subjected to chemical polishing.

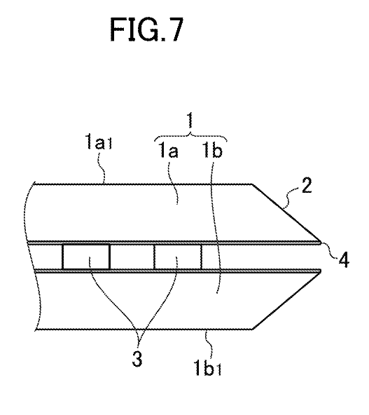

FIG. 7 is a sectional view illustrating a shape of the glass substrate pair 1 after chemical polishing. With this chemical polishing, the surfaces 1a₁ and 1b₁ and the entire end surface 2 of the respective glass substrates 1a and 1b are uniformly subjected to etching. The end surface 2 before chemical polishing is a surface which is substantially flat and perpendicular to the surfaces 1a₁ and 1b₁. Therefore, as compared to the case where the chemical polishing is performed under a state in which the broken glass edge 2a₂ is left unremoved, the end surface 2 is prevented from being formed into a sharp-edged shape.

After that, the glass substrate pair 1 is cleaned to completely remove the chemical polishing liquid.

Subsequently, the glass substrate pair 1 is conveyed to a position of a cutting apparatus to perform cutting for each liquid crystal display element section 6. With this, individual liquid crystal display elements are cut out. Thus, the at least one liquid crystal display element is formed.

According to the first embodiment, after the broken glass edge 2a₂ of the end surface 2 of the glass substrate pair 1 is removed, the glass substrate pair 1 is subjected to chemical polishing. In this manner, it is possible to prevent the end surface 2 after chemical polishing from being formed into a sharp-edged shape. Thus, it is possible to prevent generation of cracks and chips when the glass substrate pair 1 is conveyed or cut.

Subsequently, description is made of a second embodiment of the present invention. A method of manufacturing a liquid crystal display element of this embodiment includes a step of bonding the two glass substrates 1a and 1b to each other by the seal member 3 to form the glass substrate pair 1, a step of grinding the end surface 2 until the seal member 3 is exposed, and a step of subjecting the surfaces 1a₁ and 1b₁ of the glass substrate pair 1 to chemical polishing. In the following, each step is described in detail, but detailed description of steps similar to those of the first embodiment is omitted.

First, as illustrated in FIGS. 2A and 2B, the glass substrates 1a and 1b are bonded to each other by the seal member 3 to form the glass substrate pair 1. In this embodiment, the seal member 3 is arranged in two lines as an example, but the number of lines of the seal member 3 is arbitrary as long as at least one line is provided. Further, the material of the seal member 3 may be arbitrarily selected as long as the seal member 3 does not dissolve during chemical polishing. After that, similarly to the first embodiment, the glass substrate pair 1 is cut so that the outer peripheral region thereof on an outer peripheral side with respect to the seal member 3 is cut off.

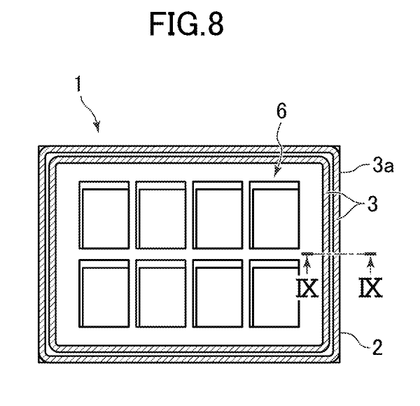

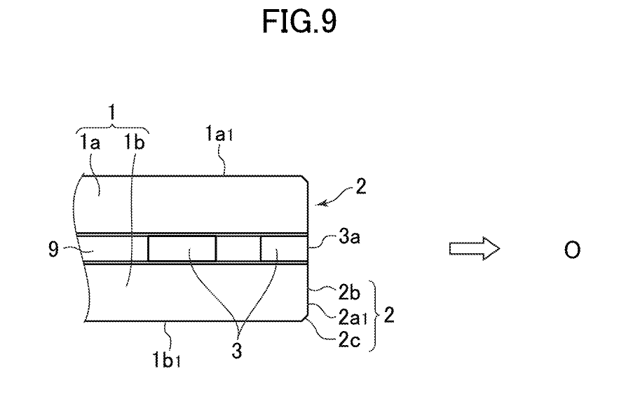

Subsequently, as illustrated in FIG. 4, the broken glass edge 2a₂ is ground by the grinding machine 8. In this case, as illustrated in FIGS. 8 and 9, the end surface 2 is ground until a side surface 3a on the outer peripheral side (O direction in the figure) of the seal member 3 closest to the end surface 2 is exposed. Note that, FIG. 8 is a plan view illustrating a state in which the end surface 2 of the glass substrate pair 1 is ground, and FIG. 9 is a sectional view taken along the line IX-IX of FIG. 8. In this embodiment, exposure of the seal member 3 refers to a state in which, as illustrated in FIG. 9, the side surface 3a of the seal member 3 on the outer peripheral side and the end surface 2 are substantially flush to each other. In this embodiment, the seal member 3 in two lines is arranged in the glass substrate pair 1, but no matter how many lines are arranged, it is only required to grind the end surface 2 until the side surface 3a of the seal member on the side closest to the end surface 2 and the end surface 2 are flush to each other. This grinding of the end surface 2 forms a state in which the seal member 3 seals a region on the end surface 2 side of the gap 9 between the glass substrates 1a and 1b.

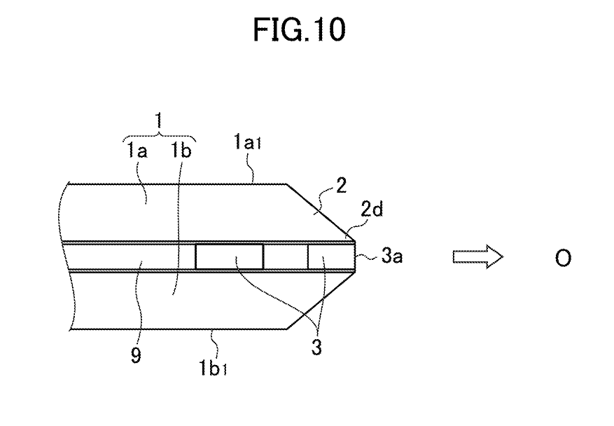

Subsequently, the surfaces 1a₁ and 1b₁ of the glass substrate pair 1 are subjected to chemical polishing. FIG. 10 is a sectional view illustrating the glass substrate pair 1 after chemical polishing in FIG. 9. With this chemical polishing, the surfaces 1a₁ and 1b₁ and the entire end surface 2 of the respective glass substrates 1a and 1b are uniformly subjected to etching. In this embodiment, the side surface 3a of the seal member 3 and the end surface 2 are substantially flush to each other, and the seal member 3 does not dissolve through chemical polishing. Therefore, an end portion 2d of the end surface 2 does not protrude toward the outer periphery (O direction in the figure) with respect to the seal member 3. The end portion 2d of the end surface 2 refers to a part of the end surface 2 in a region on the outer peripheral side, which has a plate thickness smaller than those of the glass substrates 1a and 1b. The end portion 2d is supported by the seal member 3 from the gap 9 side.

After that, the glass substrate pair 1 is cleaned to completely remove the chemical polishing liquid. Then, the glass substrate pair 1 is cut for each liquid crystal display element section 6. Thus, the liquid crystal display element is formed.

According to this embodiment, the end surface 2 is prevented from being formed into a sharp-edged shape. Thus, it is possible to prevent generation of cracks and chips when the glass substrate pair 1 is conveyed and cut.

Further, according to this embodiment, the end portion 2d of the end surface 2 does not outwardly protrude with respect to the seal member 3. Therefore, even if the peripheral edge portion of the glass substrate pair 1 comes into contact with an obstacle when the glass substrate pair 1 is conveyed, the end portion 2d is prevented from coming into contact with the obstacle. Therefore, it is possible to prevent cracks and chips of the glass substrate pair 1 more effectively.

Further, the end portion 2d is supported by the seal member 3, and hence even if a stress is applied to the end portion 2d from the side of the surface 1a₁ or 1b₁ when the peripheral edge portion of the glass substrate pair 1 comes into contact with an obstacle or when the glass substrate pair 1 is cut for each liquid crystal display element section 6, the stress is dispersed via the seal member 3. Therefore, it is possible to prevent defects such as cracks and chips of the glass substrate pair 1.

Further, the seal member 3 seals a region between the end surfaces 2 of the respective glass substrates 1a and 1b, and hence it is unnecessary to seal the region between the end surfaces 2 by an outer periphery sealing agent before chemical polishing. Therefore, as compared to a conventional method of performing chemical polishing with use of an outer periphery sealing agent, the steps can be simplified.

Subsequently, description is made of a third embodiment of the present invention. A method of manufacturing a liquid crystal display element of this embodiment includes a step of bonding the two glass substrates 1a and 1b to each other to form the glass substrate pair 1, a step of sealing a region between the respective end surface 2 of the two glass substrate 1a and 1b with an outer periphery sealing agent 7, and a step of subjecting the surfaces 1a₁ and 1b₁ of the glass substrate pair 1 to chemical polishing. In the following, each step is described in detail, but detailed description of steps similar to those of the first embodiment is omitted.

First, manufacturing is performed in a similar way as in the first embodiment until the broken glass edge 2a₂ is ground by the grinding machine 8.

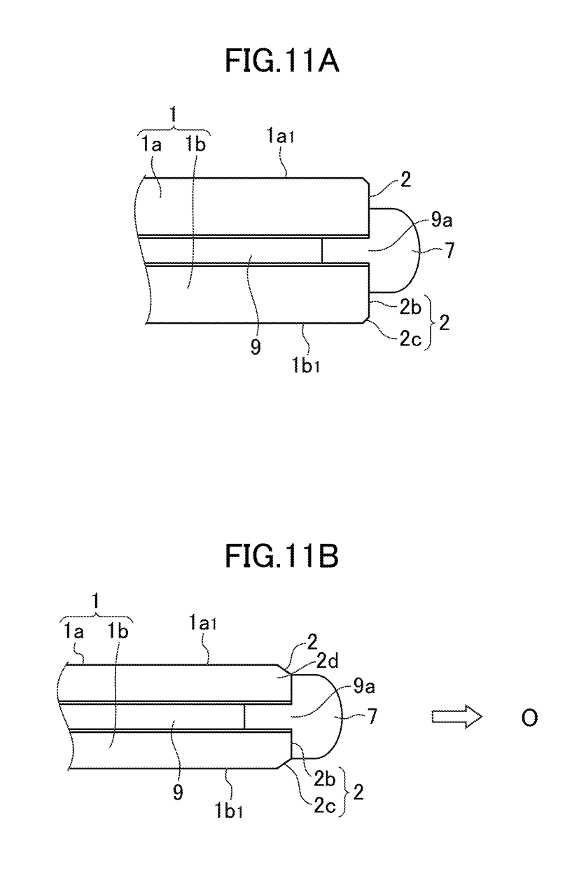

FIG. 11A is a sectional view illustrating a state in which the outer periphery sealing agent is applied to the end surface 2 of the glass substrate pair 1, and FIG. 11B is a sectional view illustrating the glass substrate pair 1 after chemical polishing. Subsequently, as illustrated in FIG. 11A, the outer periphery sealing agent 7 is applied to the end surface ground portion 2b of the glass substrate 1a and the end surface ground portion 2b of the glass substrate 1b so as to seal the region between the respective end surfaces 2 of the glass substrates 1a and 1b. The material of the outer periphery sealing agent 7 maybe arbitrarily selected as long as the outer periphery sealing agent 7 does not dissolve during chemical polishing described later. Note that, the region between the respective end surfaces 2 in this embodiment refers to a region of the gap 9 on the end surface 2 side.

The entire end surface 2 is substantially flat, and hence when this outer periphery sealing agent 7 is applied, a part of the gap 9 on a side closest to the end surface 2 (opening portion 9a) is covered at a sufficient thickness. With this, a pressure for enabling the outer periphery sealing agent 7 to enter the opening portion 9a is applied to the opening portion 9a, and hence the outer periphery sealing agent 7 enters the gap 9. As a result, the region of the gap 9 on the end surface 2 side is sealed with the outer periphery sealing agent 7.

Subsequently, the surfaces 1a₁ and 1b₁ of the glass substrate pair 1 are subjected to chemical polishing. As illustrated in FIG. 11B, with this chemical polishing, the surfaces 1a₁ and 1b₁ and the entire end surface 2 of the respective glass substrates 1a and 1b are uniformly subjected to etching. The outer periphery sealing agent 7 is not dissolved through chemical polishing, and hence the end surface 2 does not protrude toward the outer periphery (O direction in the figure) with respect to the outer periphery sealing agent 7. Therefore, the outer peripheral side of the end surface 2 is covered with the outer periphery sealing agent 7. Further, the end portion 2d is supported by the outer periphery sealing agent 7 that has entered the gap 9 from the gap 9 side.

After that, the glass substrate pair 1 is cleaned to completely remove the chemical polishing liquid. Then, the glass substrate pair 1 is cut for each liquid crystal display element section 6. Thus, the liquid crystal display element is formed.

According to this embodiment, the end surface 2 is prevented from being formed into a sharp-edged shape. Thus, it is possible to prevent generation of cracks and chips when the glass substrate pair 1 is conveyed and cut.

Further, the end portion 2d of the end surface 2 does not protrude toward the outer periphery with respect to the outer periphery sealing agent 7. Therefore, even if the peripheral edge portion of the glass substrate pair 1 comes into contact with an obstacle when the glass substrate pair 1 is conveyed, it is possible to prevent cracks and chips of the glass substrate pair 1 effectively.

Further, the end portion 2d is supported by the outer periphery sealing agent 7, and hence even if a stress is applied to the end portion 2d from the side of the surface 1a₁ or 1b₁ when the peripheral edge portion of the glass substrate pair 1 comes into contact with an obstacle or when the glass substrate pair 1 is cut, the stress is dispersed via the outer periphery sealing agent 7. Therefore, it is possible to prevent defects such as cracks and chips of the glass substrate pair 1.

Further, the end surface ground portion 2b has a surface roughness that is greater than that of the broken glass edge 2a₂, and also has fine irregularities. Therefore, it is possible to improve the adhesiveness between the end surface ground portion 2b and the outer periphery sealing agent 7. In addition, the outer periphery sealing agent 7 enters the gap 9, and hence the outer periphery sealing agent 7 is less likely to peel off from the glass substrate pair 1. Because of those points, during chemical polishing, the outer periphery sealing agent 7 can be prevented from peeling off from the glass substrate pair 1. Therefore, it is possible to prevent the outer periphery sealing agent 7 from adhering to the surfaces 1a₁ and 1b₁ due to chemical polishing.

Subsequently, description is made of a fourth embodiment of the present invention. A method of manufacturing a liquid crystal display element according to this embodiment includes a step of bonding the two glass substrates 1a and 1b to each other to form the glass substrate pair 1, a step of subjecting the surfaces 1a₁ and 1b₁ of the glass substrate pair 1 to chemical polishing, a step of cutting the glass substrate pair 1 for each liquid crystal display element section 6 to cut out each individual liquid crystal display element 6a, and a step of grinding an end surface 6b of the liquid crystal display element 6a. In the following, each step is described in detail, but detailed description of steps similar to those of the first embodiment is omitted.

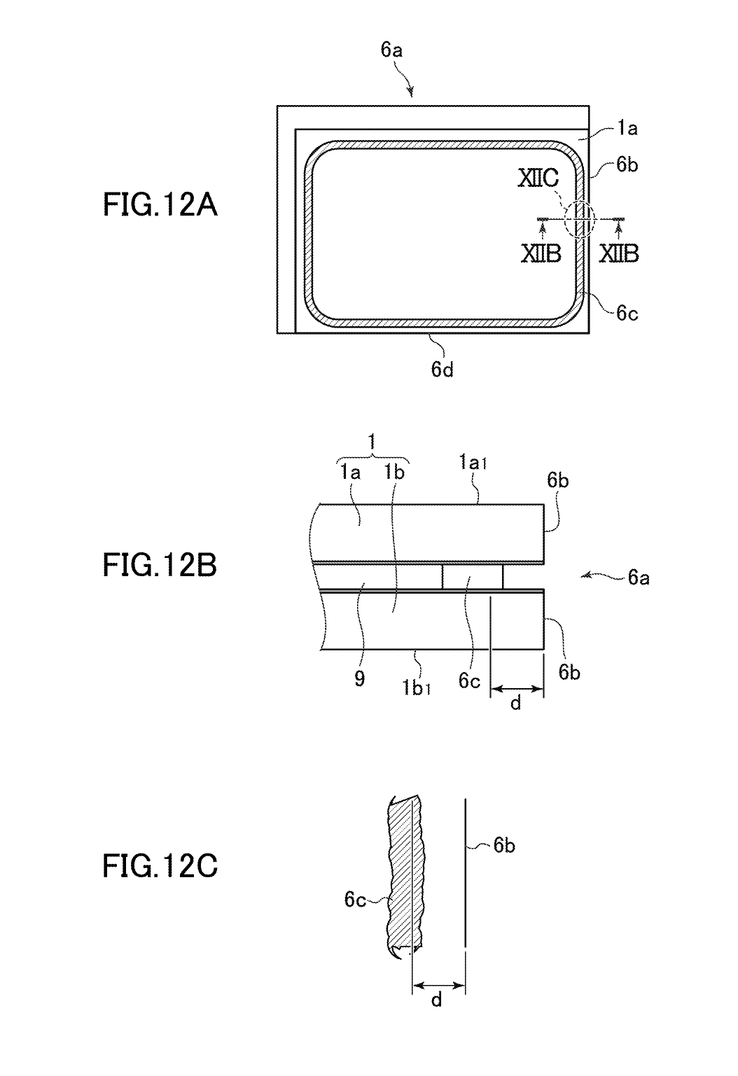

FIG. 12A is a plan view illustrating an individual piece of the liquid crystal display element 6a. First, manufacturing is performed in the same way as in the first embodiment until the glass substrate pair 1 is cleaned after the surfaces 1a₁ and 1b₁ of the glass substrate pair 1 are subjected to chemical polishing. Subsequently, the glass substrate pair 1 is cut to obtain an individual piece for each liquid crystal display element section 6 and the individual liquid crystal display element 6a is cut out. FIG. 12A is a plan view in which the liquid crystal display element 6a thus cut out is viewed from a direction of the surface 1a₁ of the glass substrate 1a. In FIG. 12A, the right side surface of the glass substrate 1a is denoted by 6b, and the lower side surface thereof is denoted by 6d.

FIG. 12B is a sectional view illustrating the liquid crystal display element 6a, taken along the line XIIB-XIIB of FIG. 12A. As illustrated in FIG. 12B, in the liquid crystal display element 6a, a sealing agent 6c such as a seal member is arranged between the glass substrates 1a and 1b so as to be positioned in the vicinity of the end surface 6b of the liquid crystal display element 6a. As illustrated in FIG. 12A, the sealing agent 6c is annularly arranged (for example, substantially in a rectangular manner), to thereby seal the region between the glass substrates 1a and 1b.

FIG. 12C is a partial enlarged view of a region XIIC of FIG. 12A. As illustrated in FIGS. 12B and 12C, the end surface 6b is separated from the sealing agent 6c by a certain distance. Subsequently, the end surface 6b of the liquid crystal display element 6a is ground. With this grinding, the distance between the end surface 6b and the sealing agent 6c is shortened. The length of this distance is not particularly limited, but the grinding is possible until the outer peripheral side of the sealing agent 6c is removed. Further, a width of the glass substrate 1b to be removed when the end surface 6b is ground until the outer peripheral side of the sealing agent 6c is removed is represented by a distance d.

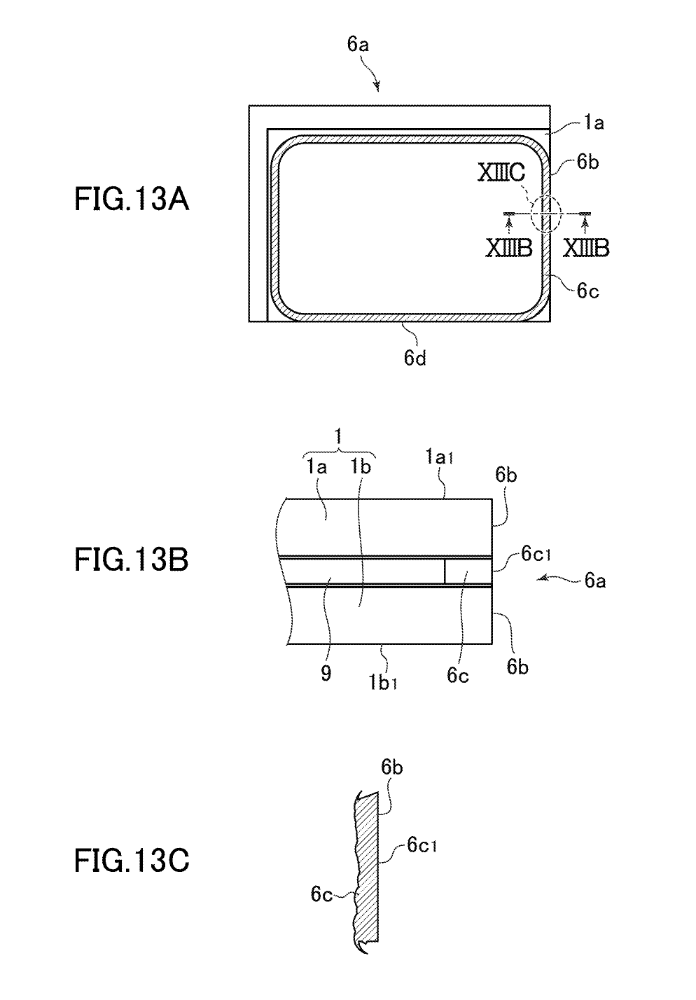

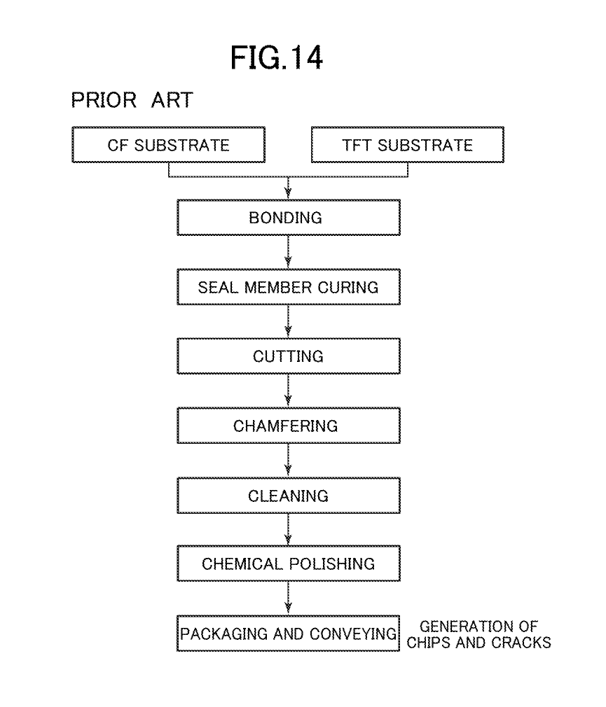

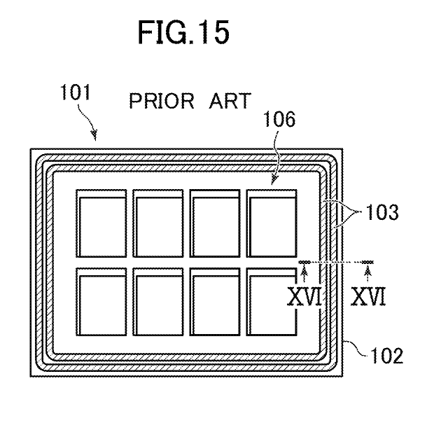

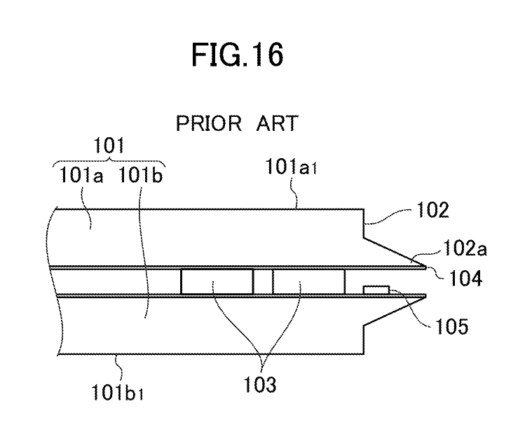

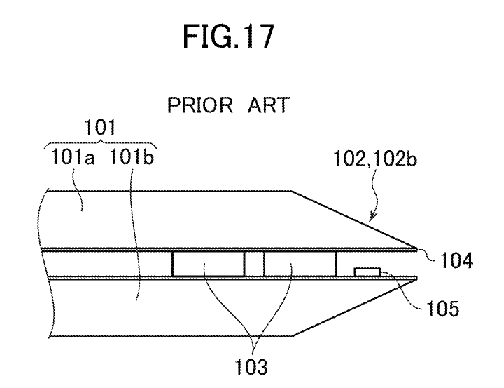

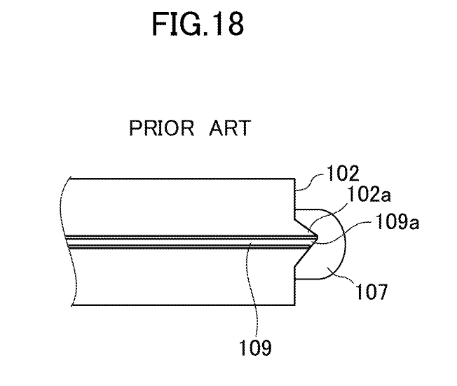

FIG. 13A is a plan view illustrating a shape of the individual piece (liquid crystal display element 6a) of FIG. 12A after the end surface 6b thereof is ground, FIG. 13B is a sectional view of the liquid crystal display element 6a, taken along the line XIIIB-XIIIB of FIG. 13A, and FIG. 13C is a partial enlarged view of a region XIIIC of FIG. 13A. As illustrated in FIGS. 13B and 13C, the end surface 6b and a side surface 6c₁ of the sealing agent 6c are substantially flat. Note that, the distance d is set as appropriate in such a range that the sealing agent 6c is not completely removed but the outer peripheral side thereof is removed to expose the side surface 6c₁. Further, the value of the distance d is set in a range that does not inhibit the strength of the sealing agent 6c and the performance of the liquid crystal display element 6a.

After that, glass powder adhering to the liquid crystal display element 6a is removed, and thus the liquid crystal display element is formed.

According to this embodiment, the end surface 6b is prevented from being formed into a sharp-edged shape, and hence it is possible to prevent generation of cracks and chips when the glass substrate pair 1 is conveyed or cut.

Further, through grinding of the end surface 6b of the individual piece of the liquid crystal display element 6a, the distance between the end surface 6b and the sealing agent 6c can be reduced as much as possible. Therefore, the frame of the liquid crystal display element 6a can be narrowed.

The present invention has been described above by means of embodiments, but the present invention is not limited to the above-mentioned embodiments, and various modifications can be made thereto. For example, the structures described in the embodiments may be replaced by substantially the same structure, a structure which has the same action and effect, or a structure which can achieve the same object.

According to the present invention, the glass substrate pair is subjected to chemical polishing under a state in which the broken glass edge of the end surface of the glass substrate pair is removed, and hence the end surface is prevented from being formed into a sharp-edged shape after chemical polishing. In this manner, it is possible to prevent generation of cracks and chips when the glass substrate pair is conveyed or cut.

Further, according to the present invention, by carrying out, prior to the first step, the step of bonding the two glass substrates to each other by the seal member to form the glass substrate pair, and grinding the end surface until the seal member is exposed in the first step, it is possible to prevent cracks and chips of the glass substrate pair more effectively. Further, the chemical polishing can be performed without using the outer periphery sealing agent, and hence the steps can be simplified.

Further, according to the present invention, by carrying out, between the first step and the second step, the step of sealing the region between the respective end surfaces of the two glass substrates with the outer periphery sealing agent, it is possible to prevent cracks and chips of the glass substrate pair, and further prevent peeling off of the outer periphery sealing agent during chemical polishing.

Further, according to the present invention, by carrying out, after the second step, the step of cutting the glass substrate pair to cut out the individual liquid crystal display element and the step of grinding the end surface of the liquid crystal display element, it is possible to prevent cracks and chips of the glass substrate pair. Further, the size of each individual piece of the liquid crystal display element can be reduced. In this manner, the frame of the liquid crystal display element can be narrowed.

While there have been described what are at present considered to be certain embodiments of the invention, it will be understood that various modifications may be made thereto, and it is intended that the appended claims cover all such modifications as fall within the true spirit and scope of the invention.

What is claimed is:

1. A method of manufacturing at least one liquid crystal display element, comprising:
a first step of grinding an end surface of a glass substrate pair including two glass substrates overlapping with each other; and
a second step of subjecting a surface of the glass substrate pair to chemical polishing.

2. The method of manufacturing at least one liquid crystal display element according to claim 1, further comprising, prior to the first step, bonding the two glass substrates to each other by a seal member to form the glass substrate pair,
wherein the first step comprises grinding the end surface until the seal member is exposed.

3. The method of manufacturing at least one liquid crystal display element according to claim 1, further comprising, between the first step and the second step, sealing a region between respective end surfaces of the two glass substrates with an outer periphery sealing agent.

4. The method of manufacturing at least one liquid crystal display element according to claim 1, further comprising, after the second step:
cutting the glass substrate pair to cut out each individual liquid crystal display element; and
grinding an end surface of the each individual liquid crystal display element.
